(19) United States
(12) Patent Application Publication
(10) Pub. No.: US 2025/0156920 A1
(43) Pub. Date: May 15, 2025

(54) BLOCKCHAIN SYSTEMS AND METHODS FOR DETERMINING SUSTAINABILITY AND/OR HEALTH RELATED PROVENANCE OF PRODUCTS

(71) Applicant: Shades of Green Group, LLC, Santa Barbara, CA (US)

(72) Inventors: Ellen Strickland, Sant Barbara, CA (US); Angela Wade, Palm Beach, FL (US); Mark Capalbo, Portland, OR (US); Patrick B. Kelly, Malvern, PA (US)

(21) Appl. No.: 18/503,847

(22) Filed: Nov. 7, 2023

Related U.S. Application Data
(60) Provisional application No. 63/382,671, filed on Nov. 7, 2022.

(51) Int. Cl. G06Q 30/0601; H04L 9/00; H04L 9/32

(52) U.S. Cl. CPC G06Q 30/0627; H04L 9/3236; H04L 9/50

(57) ABSTRACT

The embodiments of the present invention are related to automatically capturing, logging, rating, scoring, and tracing attributes of a product against known data sets and storing that information as a point-in-time capture that cannot be edited. The platform can capture, rate, score, trace, and distribute content for the health and sustainability factors/attributes of a product. A multifactor holistic scoring process is implemented that produces a reliable estimate of the sustainability of the product (in context). Related data and the score (in connection with timing information) are saved when the product (or product lot) is updated in content or manufacturing. A digital blockchain ledger is integrated by way of interaction with the system to store individual input and the score and configured to securely store the data, rules, or other items that resulted in the score. Individual data items are stored in the ledger and include an identifier.

### CROSS-REFERENCE TO RELATED APPLICATIONS

The present application is a Non-Provisional application based on U.S. Patent Application No. 63/382,671, filed Nov. 7, 2022, which is incorporated herein by reference in its entirety.

### BACKGROUND

### Technical Field

The present disclosure is directed to the field of providing electronic sustainability, compliance, and safety related services in connection with commercial products, such as retail consumer products.

### Background

There is currently an important trend in the world directed to transitioning or improving the sustainability of commercial products (such as beds, clothing, or houseware). This is sought by consumers and companies. There are various technical obstacles and problems in this field. For example, an accurate or reliable estimation of the sustainability of a product can be very difficult to determine, independently determine, or verify. An item may have multiple ingredients, involve different shipping techniques, involve different countries of manufacture, or involve various environmental notices (e.g., a notice in California may be different from a federal notice). The supply chain, manufacturing process, or company information can all impact the overall sustainability of a product. Seller oftentimes provide a general narrative and ingredients (as required by law), but this cannot be parsed to arrive at a reliable estimation. The information may also not include or combine safety or hazard information related to the product and its ingredients. In addition, the information may lack objectivity or current information such as recent changes in environmental mandates about a material. Reliability can also be an issue in that a rating may be set, but the underlying information could change and the system would not update. The data is also not independently verifiable or stored to allow tracing and confirmation of the sustainability. These and other deficiencies are sought to be addressed.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1A and FIG. 1B together show an illustrative simplified view of data categories, score categories and an overall process for a system in accordance with one or more embodiments of the present invention;

FIG. 2 is an illustrative graphic representation of the scoring mechanism system output (e.g., as an image or data that is used to a graphical illustration), in accordance with one or more embodiments of the present invention;

FIG. 3 is an illustrative process and block diagram representation of a portion of an overall process, in accordance with one or more embodiments of the present invention;

FIG. 4 is an illustrative process and block diagram representation of a portion of an overall process, in accordance with one or more embodiments of the present invention;

FIG. 5 is an illustrative functional block diagram of the system, in accordance with one or more embodiments of the present invention;

FIG. 6A and FIG. 6B together show an illustrative functional block diagram of the system architecture, in accordance with one or more embodiments of the present invention.

### DETAILED DESCRIPTION

Like numerals refer to like elements throughout the specification. Not all elements of embodiments of the present disclosure will be described, and descriptions of what are commonly known in the art or that overlap each other in the embodiments will be omitted.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence, or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements, but not the exclusion of any other elements.

The embodiments of the present invention are directed to automatically capturing, logging, rating, scoring, and tracing attributes of a product against known data sets and storing that information as a point-in-time capture that cannot be edited. The platform can capture, rate, score, trace, and distribute content for the health and sustainability factors/attributes of a product. A multifactor holistic scoring process is implemented that produces a reliable estimate of the sustainability of the product (in context). Related data and the score (in connection with timing information) are saved when the product (or product lot) is updated in content or manufacturing. A digital blockchain ledger is integrated by way of interaction with the system to store individual input and the score and configured to securely store the data, rules, or other items that resulted in the score. Individual data items are stored in the ledger and include an identifier. The system is configured to reuse the data with the identifier in the ledger by including the data item in a block for a current score for a product and in a block for a previous score for that product by using the same identifier and data value for the item in both blocks.

Embodiments of the present invention are related to systems and methods for intelligent assessment and presentation of the environmental and/or personal health impact of products, as well as their sustainability in sourcing, production, transportation, use and disposal. Information is gathered from the producers, suppliers, users, recyclers, third-party experts, researchers, governmental, and non-governmental organizations.

This information includes, but is not limited to, regulatory information, toxicity reports, import/export restrictions, transportation information, pollution reports, Material Safety Data Sheets (MSDS), product testing reports, lab reports, and chemical analysis.

This information is systematically gathered, analyzed, and recorded in a database, preferably every time a change is detected in any input (or a specified set of inputs). This is a temporal event to which the system is responsive. The information (or data) can be triggered by a change either internally (internal to the functioning of the system), such as a rule change in an implemented model or a rebalancing of weights, a producer updating or adding product information, or a change to any third party, governmental, or other information, which is scanned on a regular basis, such as weekly or daily.

Once the system performs a process of analysis, an objective metric of each type of impact (sourcing, manufacture, shipping and packaging, health & performance, lifecycle) is produced, as well as a combined impact metric.

The system, using an implemented model, then analyzes the possibility of using alternative materials, processes, methods of transportation and sourcing, as well as possible disposal improvements or re-use opportunities, weighing applicability, cost, and availability. These opportunities are combined with the impact factors to produce final scores in each area, considering geographical and industrial factors, as well as the veracity and completeness of each input. For example, the system may determine based on its database of information that there is no stored alternative to a particular material or sourcing (or other parameter) and the system may apply this in the model to increase the score to be higher reflecting a better outcome for the product.

Upon creation of the final scores (which is sometimes referred to as a Scoring Event), a snapshot of preferably all inputs, models, scores, and associated outputs are recorded and archived in the database. A cryptographic hash function produces a checksum, preferably for each information item, as well as a global unique identifier (GUID). The GUID and checksum for each information itemare then recorded on the blockchain in an immutable transactional block to establish the canonical version of the score for that point in time and the exact information environment in which or from which the score was created. If a particular item of information has not changed, its GUID and checksum may also appear in another transactional block (recorded as a part of a different scoring event) as well, but will be recorded each time it is used in the scoring process. Preferably the information items, meaning the types of items, are predetermined within the system and with respect to inputs can only be those that are used as part of a process that produces the impact or score that is generated for the product. Other fundamental information such as data and/or time may also be part of the predetermined information items. In some embodiments, less than “all” inputs, models, scores, and associated outputs are recorded, archived in the database, cryptographically hashed to create a checksum, and assigned a GUID. For example, in some embodiments, the system may not produce a cryptographic hash for certain types of information items. In another example, the system may not necessarily need to record an information item in the database if it is known to be the same for all data or is separately saved.

Once recorded in the transactional block, the system creates visual artifacts for producers or other users of the system to display to their customers to represent their scores in whatever form is best for their uses. These include, but are not limited to, printed data, electronic feeds to their computer systems, pre-rendered images, web pages, and/or an automated programmatic interface (API) for their systems to use to retrieve information.

In addition to the score information, the system using the implemented model also creates a detailed traceability description of the decisions that were triggered to produce the score, as well as a list of related previously stored information items that preferably include recorded recommended improvements to decrease the impact of the particular product and increase its sustainability. If desired, the system can deliver the information to the interested party automatically (e.g., via a graphical display or email) or in person by a consultant representative.

The system can send a notification or alert via email, direct message, or other means to producers, consumers, or other users of the system when a substantive change to a score occurs. Each user can opt in or out of this feature at any time and their preference will be saved by the system in the user's profile.

The system can also provide custom ratings for users who may have sensitivities or special conditions. Users can customize the attributes and weighting factors they place on particular aspects or areas of the evaluation process. These customized ratings can appear in their user profile or can dynamically be displayed alongside the standard ratings, even when displayed on a retailer's or other system user's website.

The system provides additional metadata and ratings in both the electronic data format and pre-rendered format to allow retailers, users, and consumers to place filters on ratings.

The system also incorporates a history browser that allows a user to browse backwards through previous scoring events. This history can be explored by product, date, input changes, rule changes, or other information to see the exact conditions, as well as results of a previous scoring event. These histories are registered in transaction blocks on the blockchain with the assurance that nothing has been changed since that scoring event by using the GUID recorded in the transaction block for each information asset and validating the information with the checksum. This information is combined and presented to the user in the application format that they normally use to browse current data with appropriate notification that they are not viewing current data.

With respect to inputs, certain types of information can be collected and used as inputs to the system for the process. A product name, descriptions, characteristics, and identifying information can be entered into the system. Company information can be entered into the system that details information about the product manufacturer(s). Sourcing information used to collect the product raw materials is entered into the system that identifies, including but not limited to: locations, methods, safety and hazard protocols, waste management, health impact to workers, sustainability, and impacts to the environment.

Manufacturing process information associated with the manufacture of the product is entered into the system that identifies including but not limited to: product production processes, raw materials, chemicals or additives involved in production and cleaning of production equipment and facilities, by-products, waste, geographic location of sources, location of manufacture, production and application regulations, laboratory reviews, safety and hazard protocols and compliance, energy use, water quality, air quality, and/or health impact to workers.

Shipping process information associated with the packaging, storing and transport of the product is entered into the system that identifies including but not limited to: packaging materials, packaging process, storing and distribution, transportation method, energy use, fuel use, waste management, and/or safety hazard compliance.

Health and performance information associated with the human, animal and environmental impact of the product is entered into the system that identifies including but not limited to: product use, health impact to consumer, impacts to environment, waste management hazards, performance standard compliance, and/or people, animal and/or environmental exploitation identification.

Lifecycle and use information associated with the product is entered into the system that identifies including but not limited to: product design designation, reuse, disposal, disassembly, recyclability, compostability, product design in accordance with system circularity best practices, product disposal impact on land, air, water, people, animals, waste management impact on land, air, water, people, animals, and/or activities associated with take-back, recyclability, reuse, habitat restoration, and/or pollution remediation.

If desired, information that is not entered, for example, based on the lack of information from a collection source can be left open (blank) or assigned to another collection source.

Hereinafter, some embodiments of the present disclosure will be described in detail with reference to the exemplary drawings.

With respect to rule set and details of rule sets, various embodiments are contemplated. When all information is gathered, the collected information is reviewed and validated by the disclosing company and the approval process may take place. Preferably, the system is configured to have a system user and/or authorized representative from the disclosing company approve the information items collected for the product for use in the analysis process. The system is configured to compare collected information items against a knowledge data set (developed and saved by the operator of the system) and third-party data sets including, but not limited to: chemicals used, materials used, manufacture process used, legal compliance information, regulatory information, certifications, sustainability best practices, laboratory reports, and/or calculations.

The comparison produces results that are recorded and scored inside a/the scoring engine for five areas of disclosure including but not limited to: sourcing, manufacture, shipping, and packaging, health & performance, lifecycle). Scoring is performed according to the rules in the system in each of the five areas (sourcing, manufacture, shipping and packaging, health & performance, lifecycle).

The system can check several product characteristics, including but not limited to, chemicals, ingredients, processes, certifications, and recycling, against internal and external information (e.g., stored in the system database) to assess their impact on the scores in each of the five areas.

The system is configured to weigh differently certain areas, life stages, and categories in accordance with their impact to the consumer of the product, household, and community, as well as societal and global impacts.

The system is configured to produce scores that are attenuated based on diminishing returns for repeating or overlapping benefits or hazards. For example, two certifications (e.g., industrial certifications) in different areas may double the points added to the score, but one hundred certifications will award less than one hundred times the score for one. Also, the system can be configured such that two overlapping certifications may award less than twice the benefit to the score.

The scores calculated through this process are then mapped into a range from zero to five points. This mapping can include a process step in which the system is configured to factor into the analysis the expected range of scores based upon several factors, including, but not limited to, the industry, category, region, availability of information, completeness of the application, and relative ranking to similar products.

The five scores (sourcing, manufacture, shipping and packaging, health & performance, and lifecycle) are then combined into an overall score for the product.

The system can be configured to identify where input data is deemed inconsistent, incongruent, or out of compliance against known regulations, best practices, or plausible methodologies.

With respect to outputs and details of outputs, the score and corresponding data sets are identified, hashed, and stored to capture a point-in-time copy of the information used to assess the product, including but not limited to, the manufacturer submitted information, internal reference data, data from external third-party sources, regulatory information, third-party analysis, and the rules in the system. For example, there can be stored a score storage snapshot (five separate hashes per rating) and storage of the score and corresponding data sets on the blockchain.

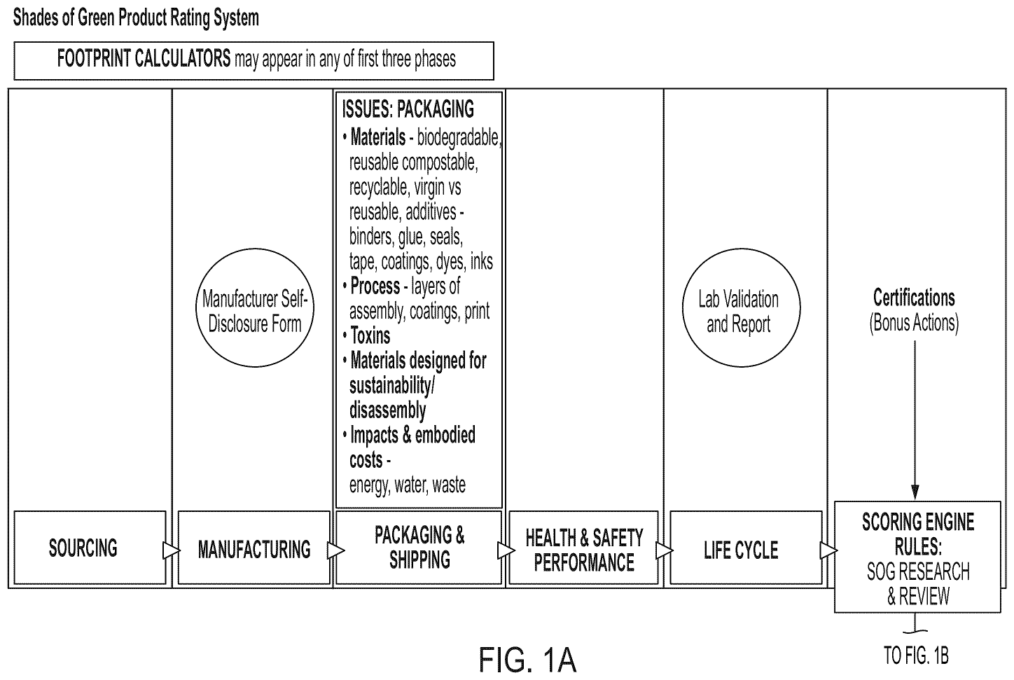

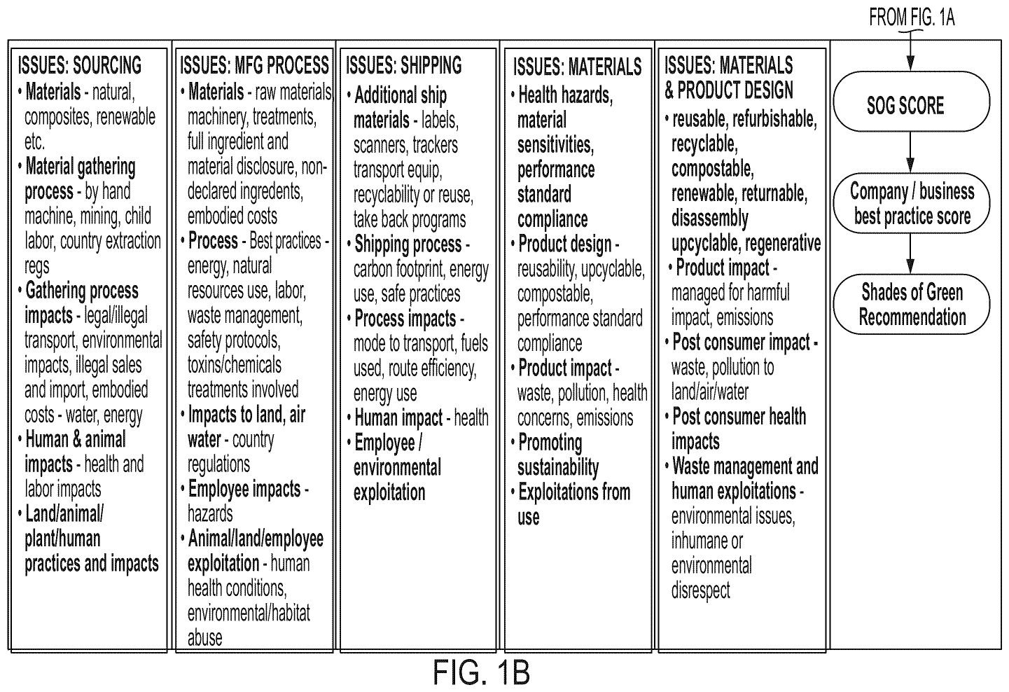

FIG. 1A-B is an illustrative representation of the data and process implemented by the system. Further system and process details are provided herein. FIG. 1A-B is exemplary with respect to the data types and categories and also a high-level process flow that is computer implemented by the system.

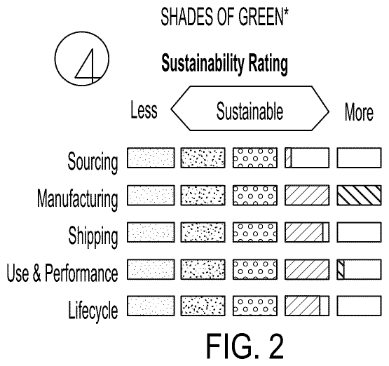

A graphical representation (generated by the system) of the textual, numerical, and graphical display of scoring is provided in FIG. 2.

The system is configured to produce recommendations to improve scoring by category based on stored database information. The system can be configured to identify any negative or neutral score(s) and use those scores for producing a recommendation. A flagged input (identified based on the score) in any area is compared against data sets for that particular area. A recommendation is generated by comparing existing inputs against higher scoring inputs that improve the score. For example, an output produced for a particular phone charger can be to improve the carbon footprint by moving it to the U.S. to manufacture, improve sourcing location for heavy metals, product design change to improve universal access of phone, and select distribution and delivery partners that employ more sustainable practices. In another example, an output produced for a particular mattress can be to source alternatives to plastic shipping materials, improve the carbon footprint by sourcing latex material closer to the point of manufacture, and select distribution and delivery partners that employ more sustainable practices.

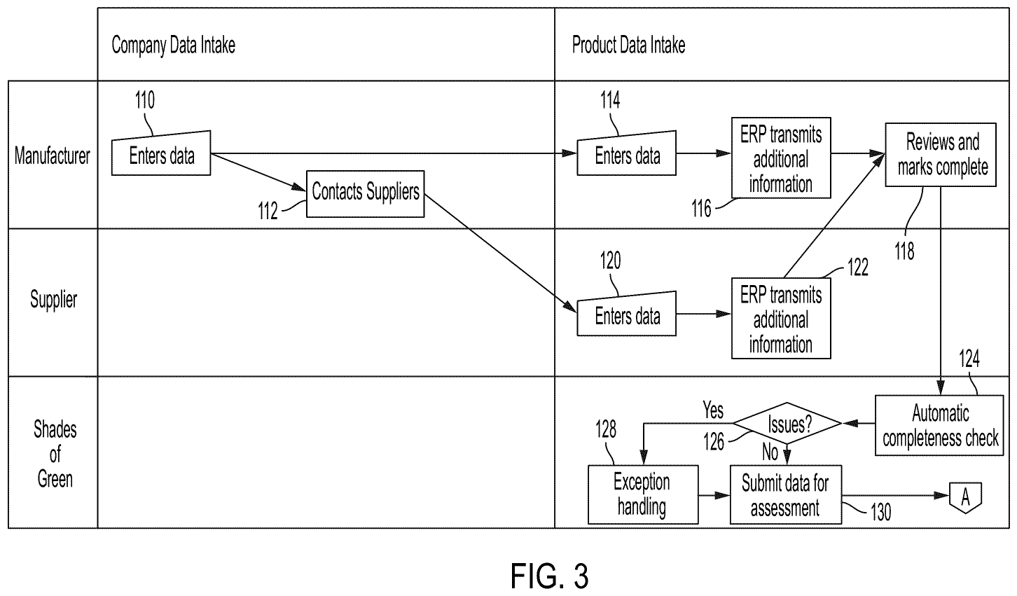

FIG. 3 is illustrative of systems, methods, or computer-readable medium and related configured functionality in accordance with one or more embodiments of the present invention. The functional block diagram contains illustrations of steps involved in the compilation, aggregation, and update of data in association with a particular product. At step 110, data is entered into a computer using a software application that provides data from the manufacturing company to provide input of information assets directed to company data intake. The data can be entered through a GUI. The data can be automatically, without user intervention, collected from one or more data sources (e.g., over a network), such as from internal databases of the manufacturer. Or, for example, the data can be manually entered by the manufacturer answering certain questions about the company such as by a questionnaire in a software application. At step 112, other companies or sources, such as suppliers of the manufacturer, are contacted such as via an electronic email or a software website link, and data is entered. Data can be entered into a computer such as by using a software application that provides data from the manufacturing company to provide input of information assets directed to company data intake. The data can be entered through a GUI. The data can be automatically, without user intervention, collected from one or more data sources (e.g., over a network) such as from internal databases of the supplier. Or, for example, the data can be manually entered such as by the supplier answering certain questions about the supplier such as by answering a questionnaire in a software application.

At step 114, a product data intake process is initiated for a particular product. At step 114, data is entered into a computer such as by using a software application that provides data from the manufacturer company to provide input of information assets directed to product data intake. The data can be entered through a GUI. The data can be automatically, without user intervention, collected from one or more data sources (e.g., over a network) such as from internal databases of the manufacturer. Or, for example, the data can be manually entered such as by the manufacturer answering certain questions about the product such as by answering a questionnaire in a software application. At step 116, the enterprise resource planning system of the manufacturer transmits additional information related to the particular product. The process may involve the system being configured to have an electronic interface with the company's enterprise resource planning system to receive the data. At step 118, the inputted data including the ERP-provided data are reviewed and, in response, the collected information assets are marked complete. If the product involves supplier or supplier data, a data intake process is performed with the computer systems of the supplier. At step 120, a product data intake process is initiated with a supplier for a particular product (e.g., a supplier of raw material included in the final product). At step 122, data is entered into a computer such as by using a software application that provides data from the manufacturer company to provide input of information assets directed to product data intake. The data can be entered through a GUI. The data can be automatically, without user intervention, collected from one or more data sources (e.g., over a network) such as from internal databases of the manufacturer. Or, for example, the data can be manually entered such as by the manufacturer answering certain questions about the product such as by answering a questionnaire in a software application. At step 122, the enterprise resource planning system of the supplier transmits additional information related to the particular product to the next step (such as step 118). The process may involve the system being configured to have an electronic interface with the supplier's enterprise resource planning (“ERP”) system to receive the data. At step 118, the inputted data, including the ERP-provided data, are reviewed and, in response, the collected information assets are marked complete. The system can involve an automated process in which the system automatically connects and collects data, such as information items from the supplier or manufacturer's ERP system.

Product and company data intake is received and stored by the sustainability provenance system. At step 124, the system receives data input providing product and company data input obtained from the manufacturer of the particular product, tollers, contract manufacturers, and from any suppliers involved, such as from step 118, after the data is reviewed and marked complete. Step 124 can also involve an automatic completeness check. The system is configured to conduct an automatic completeness check during which an automatic process applies a completeness verification check to determine whether the input providing manufacturer and/or supplier information data is complete. At step 126, the system is configured to handle the determination of whether there are issues such as missing data (or unanswered questions) in the collected data for the particular product. At step 126, in response to detecting that there is missing data (for example) in data intake (such as by comparing the provided data against a set of ranges or characteristics that they are to meet, the system branches into two alternative paths. At step 128, the system is configured to perform exception handling in the event there are issues with the collected data. This can, for example, involve setting some of the parameters to be blank or implementing rules that may trigger one or more messages to the manufacturer or supplier. At step 130, the system is configured to submit the data to be applied to subsequent system processes, such as being applied to a scoring engine.

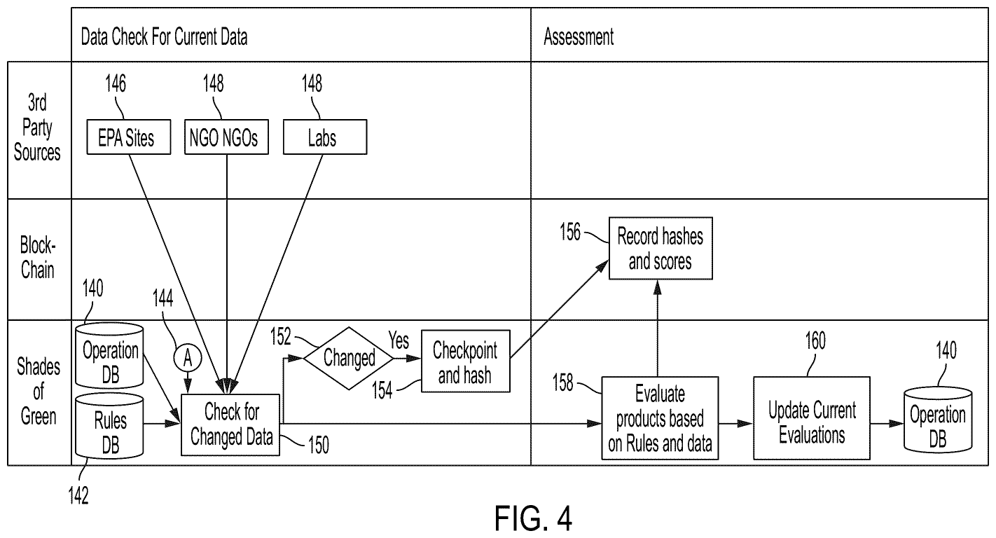

FIG. 4 is illustrative of systems, methods, or computer-readable medium and related configured functionality in accordance with one or more embodiments of the present invention. The functional block diagram contains illustrations of steps involved in the compilation, aggregation, and updating of data as well asthe steps involved in determining, tracking and maintaining sustainability and sustainability provenance for a particular product. The system is configured to provide a resource for a database of products that have been the subject of an illustrative process of the claimed invention, such as that shown in FIG. 3. In this figure, for ease of understanding, there are combinations of functional blocks and illustrative steps that describe features of the system in accordance with one or more embodiments.

Operation database 140 is configured in the system to implement data stored by the system for use in the operation of the overall system and related processes. Rules database 142 is configured in the system to store a collection of rules, as mentioned above, that configure the operation of the system to process the collected data and apply the rules to the collected data to perform related actions. Step 144 is provided to indicate the output of the illustrative process of FIG. 3 and, consequently, the system receiving and storing the collected data for further operation. Operation database 140 may store previously retrieved or collected data (e.g., automatically by way of data communication) from sources (e.g., external sources) that is used by the rules as part of applying the collected data to the rules. This external data may, for example, be reference or threshold data, or potentially other types of data such as certifications, health warning, or options for alternatives. This external data can be, for example, data from the Environmental Protection Agency 146, such as directly from their sites, from NGOs 148, or one or more laboratories that conduct analysis or reports related to safety and sustainability of supplies, resources, manufacturing techniques, or other germane information.

Step 150 is configured to provide a process that checks for changed data from external sources, collected data (e.g., from manufacturers), or other updates, such as updates or modification to rules, in database 140. Step 150 can operate as a trigger that initiates a subsequent process when a change in the data or rules (used in previous processing in a scoring engine) is determined. Step 150, by referring to change, is also referring to new data such as the addition of a new product and its related data. The changes can be stored in databases 140 and 142 and the system is configured to take further action (e.g., add certain data to the blockchain), in response to detecting a change to specific data, such as specific information assets.

The system is configured at step 158, in response to a detected change, to apply a scoring engine that uses the rules and data to produce one or more outputs. For example, a score is generated for specific categories that is based on inputs and external data that represents and produces a value that communicates the intrinsic state of sustainability in that category as calculated using data collected about the product (including such things as manufacturing process, source country, materials, and alternative materials or suppliers). The output of step 158 is saved and recorded in a block on the blockchain in step 156. The addition of the output to the blockchain involves using encryption as part of the blockchain protocol to secure the data from modification. Preferably, the system generates a new score when data used or included in generating the score is updated and the system adds the new score to the blockchain in a block and maintains the previous score in the blockchain as well. In other words, an overall score for a particular product may have been saved to the blockchain at Noon on Oct. 1, 2022. In response, to receiving information the current lot of that product contains wood for a different country, the system operates in response to identifying that the data has changed and produces a new score by applying the scoring engine. The system is configured to add that new score to the blockchain with the new time (e.g., Oct. 10, 2022 at 3 PM EST) and preferably would not delete or modify the score added at Noon on Oct. 1, 2022.

For new information assets or changed information assets, the system is configured via steps 152 and 154 to detect that data and operate on each information item (e.g., a single value) to generate a cryptographic hash function that produces a checksum from and for that information item. The system also produces a global unique identifier (GUID) for each information item. The system is configured to store (such as in operations database 140), if necessary, the GUID and related information that defines or communicates the specific type or category that correspond to that GUID and may store other related data. For example, the system is configured to track that a certain GUID corresponds to one of the materials used in making a particular product. This provides meaning when the data is retrieved from the blockchain and is used in the system. The information items that are added to the blockchain define all or a subset of all of the data that is used by the system to produce an individual score. This provides verification of the scores, if needed. The rules associated with the production of that score can also be stored in the blockchain to provide additional definition of the context and data that resulted in the score.

At step 160, the system can be configured to save the new or updated scores or evaluations to the operations database 140 (shown twice in the figure for clarity).

As part of step 158 and the execution of the rules engine, the system is configured to produce a score and based on the score, determine if there is additional information providing alternative options to the manufacturer to raise the score for that product. As mentioned above, the rules engine can also include a context check that applies information saved about whether there is a reasonable alternative or alternatives to a collected information item to adjust the score so as to raise the score. This end-adjustment rule adds a cumulative layer of accuracy to the process and score.

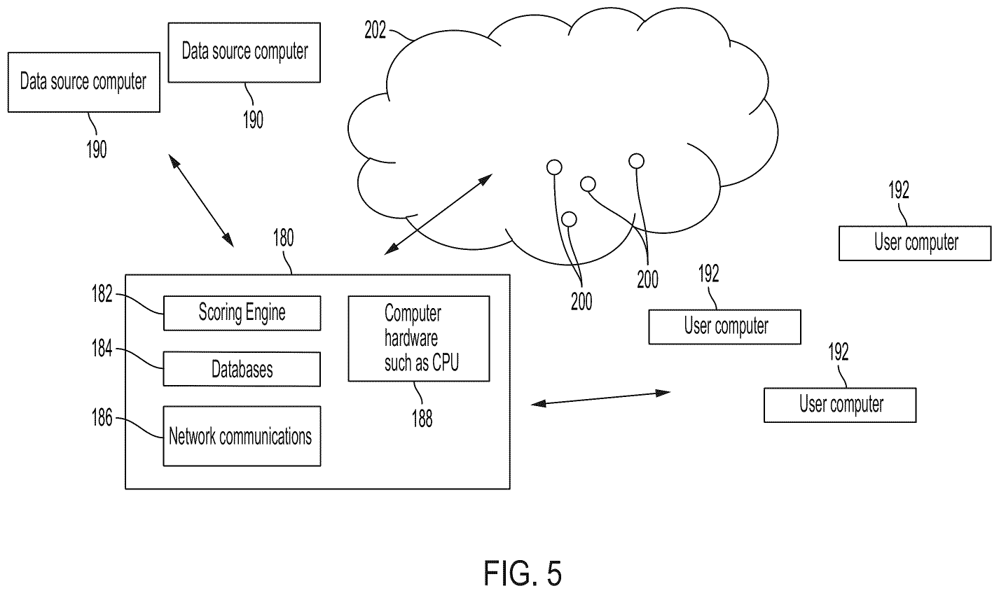

With reference to FIG. 5, a functional block diagram is provided for illustrative purposes in accordance with one or more embodiments of the present invention. One of the features of the system can be to provide a software application or software as a service (an online resource) that displays for the user historical changes to the score of a particular product. The system can be configured to retrieve data stored in the blockchain for a particular product and display in a series, such as a series of numerical scores and corresponding dates, or in a graphical form that shows fluctuations to the user. The information can be displayed on user computers, such as consumers, to illustrate the progress of the product in sustainability. The system can be configured to display the related information assets that are included in the score and/or resulted in changes in the score. A functional block diagram for the computer system that provides the described functionality is provided at block 180. The diagram provides illustrative information without being exhaustive in that features or functionality of computer system 180 are also communicated elsewhere herein. Computer system 180 includes databases 184 that is stored in storage medium (e.g., as part of hardware 188) of computer system 180. The computer system includes network communications circuits and software that is configured to communicate over networks such as the Internet, VPNs, or private networks to communicate with user computers, collect data, and interact with the blockchain. Computer system 180 is further described below.

As discussed above, system 180 is configured to operate to provide various features and services, including communicating with user computers 192, to accomplish actions such as displaying or providing scores for a particular product or graphically displaying a history of scores for a particular product. System 180 is also configured to generate in response a score to produce a graphical representation of the score for that product and send that graphical representation to display in an ecommerce site to display the score (graphical representation) on the ecommerce site's product page for that particular product. Data source computers 190 are, for example, source computers for data collected by the system. Computer system 180 is configured to communicate with blockchain 202 and add scores and information items to the blocks in the blockchain 202. Computer system 202 is also configured to retrieve data such as in response to a user computer seeking to view a score history from the blockchain and prepare and display the score to the user such as by sending the score in a browser.

The blockchain system 202 includes a plurality of node computers 200 and a communications network connecting the plurality of node computers 200. Each node computer in the plurality includes a processor, memory storing computer instructions executable by the processor, and a network interface operatively coupled to the processor and the communications network, which may be a wide area network such as the Internet. The blockchain system 202 is implemented with a blockchain consensus software application (blockchain consensus protocol). The blockchain consensus software application is adapted to connect to the plurality of node computers 200 through the communications network. The blockchain consensus software application configures the blockchain system 202 to operate using the data structures used by computer system 180 and related features illustratively described in this application. Communication between node computers 200 are by way of digital messages constructed by the node and transmitted to other node computers using packets over a communications network.

Through a software application, node computers 200 can operate to reach a consensus on adding transactions (such as the transfer of or changes in data fields or information related to ownership) to an overall transaction record maintained by the blockchain system and have an agreement on what the overall transaction record is. Each node 200 in the blockchain system 202 may be referred to as a consensus node. The transactions may be temporal events that add information to the blockchain (based on user identifier information such as cryptographic wallet information). The overall transaction record is where all the transactions processed through the blockchain system 200 are stored. The overall transaction record is kept in the form of a blockchain. Node computers 200 in the blockchain system each has its own copy of the overall transaction record or blockchain. A node computer might have a different copy of the overall blockchain temporarily, but node computers will eventually agree on a same overall blockchain. The “blockchain” means a distributed ledger in which transactions are maintained across several node computers that are linked and immutable in a peer-to-peer network. “Maintain” means that each node computer has a local copy of the blockchain or transactions processed through the blockchain system and can update its local copy when new transactions or proposals are received in the blockchain system 202. It would be understood that examples of the blockchain, such as for storing or maintaining NFT, include Ethereum, Solana, and Cardano.

A block refers to a block on a blockchain or a block to be added onto a blockchain so that it extends from the latest block from a blockchain. A block may include transactions, hash of the previous electronic block, hash of the current electronic block, a timestamp, Merkle root, target, nonce, and other information, or one or more of the aforementioned.

A network used for the overall is a wide area network and is preferably the Internet. A network can comprise a plurality of computers including networking equipment for implementing communications and traversal of messages or packets between computers and applications. Computer nodes that implement a network can include or overlap with the other computers or devices mentioned herein, such as user devices (e.g., mobile phones).

As discussed herein, the GUID can be a set of numbers, letter, characters, or other symbol(s) that can be used as a name or identifier for the information item. Preferably, each information item has a unique identifier in the system such that there no other information items assigned the same GUID at the same time. It is understood there can be variations in that each number may not necessarily be unique in that, for example, a combination of an identifier and another piece of data can together provide unique correspondence to an information item.

Also, as discussed, the system is configured to maintain a produced checksum and GUID for an information item when the information has not changed. As such, that GUID and checksum would be saved and be associated with a current or past score that is saved in the blockchain that is the same or identical in each of those cases.

In accordance with embodiments of the present invention, an automated provenance system is provided that is configured to capture, compare, log, store and retrieve mechanisms. Embodiments of the present invention provide an automated product evaluation system.

In general, the system is configured to be independent from manufacturer, suppliers, and mentioned third-party system. This configures the system to operate independently and external from systems that provide the product intrinsic data used in the process of the system. Also, the system is configured to be current or live in that the system monitors, collects, retrieves, and/or receives updates and, in response, updates (immediately) and produces a new score from a triggering event and adds the score and data context to the blockchain. This can provide real time or near real time updating to produce scores across many products, such as when new information about the hazards of material is recently determined.

Embodiments of the presentation provide a system that uses multiple inputs from an incorruptible electronic ledger (using a blockchain), and/or API and/or manual disclosure to collect product provenance information, product materials (e.g., product ingredients), handling, shipment, manufacturing, certifications, packaging, and transportation details of a product. The ledger is writeable and assignable by one of any number of approved parties by way of computer connections. The ledger stores and sends data to a database and scoring application. In some embodiments, the database can receive inputs from the ledger and rate/score the product, as described herein, against existing scientific data, proprietary information, existing certification criteria and third-party data sets (available from internal or external databases or sources). This is a variation of the above description.

The system is configured to provide a score (an estimate of sustainability by category or cumulative that uses intrinsic product data) for each product manufacturing lot or instance of an input, writes to the ledger, identifies issues that may warrant further investigation, and requires third-party certification/validation or contain anomalies that need to be resolved. The system is configured to identify issues such as errors in the data or rules, or may identify areas of improvement based on alternative data stored by the system. If desired, the system is configured to communicate with a third-party server in connection with a specific piece of information to request that the third-party server validate or certify the information. In the figures, this can be a communication exchange with one of the external servers or computers (e.g., the EPA server).

As discussed, embodiments of the present invention are configured to create and store a non-corruptible point-in-time snapshot of the entry data, evaluation criteria and results (score) at a point in time, such as in response to a trigger of a change of data or rule.

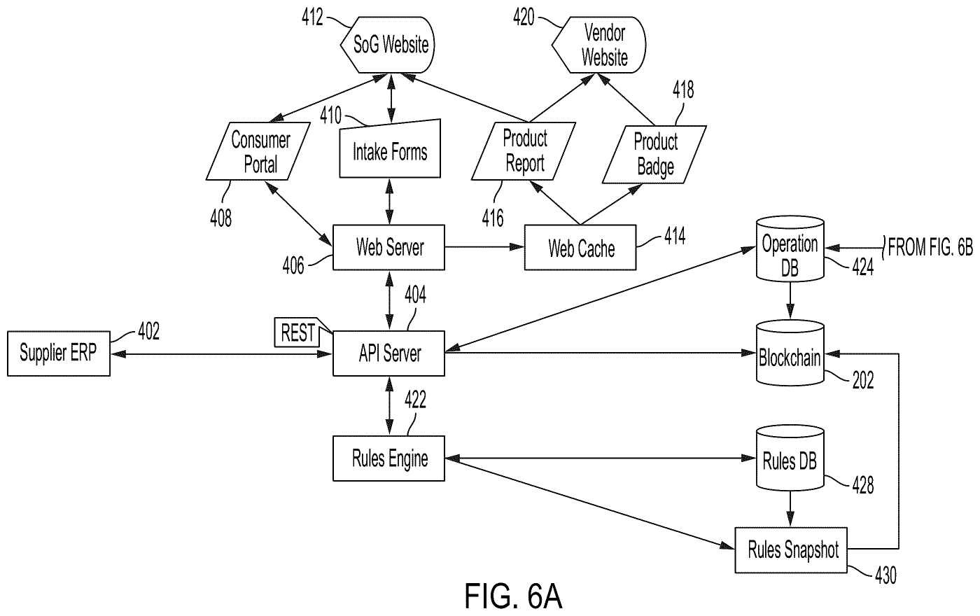

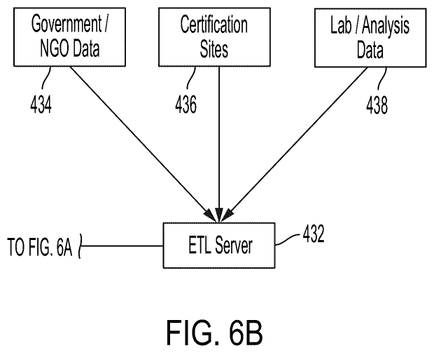

With reference to FIG. 6A-B, a functional block diagram is provided for illustrative purposes in accordance with one or more embodiments of the present invention. FIG. 6A-B is illustrative of a combination of a system architecture and related processes. FIG. 6A-B also restates some of the relationships or functionality of the system and includes some new features. In operation, Supplier ERP 602 can be a computer system of a product supplier that is configured to communicate and provide information items and related information to the API server 404 via a communication connection. ERP refers to an enterprise resource program. An API is an application program interface and the API server is configured to operate as the program interface for the contemplated system's operation.

The API Server 404 is configured to communicate with web server 406. Web server 406 is a computer system configured as a world wide web server. Web server 406 is configured to implement or support consumer portal 408, intake forms 410, SoG website 412, web cache 414, product report(s) 416, product badge(s) 418, and vendor website 420. Consumer portal 408 provides an interface through which consumers can interact with the system to a review product, rating, or other information. Intake forms 410 are configured as digital documents for intake of products. The SoG website 412 is configured to be the website of the company that provides the described services (SoG is an acronym of a company name). Web cache 414 is a cache that is configured to store product reports, ratings, and product badges (e.g., FIG. 2) as a quick and efficient resource that stores prepared materials that are served from the cache (quickly due to the general functionality of caches). Product reports 416 and product badges 418 have been described herein. Vendor website 420 can receive a product badge or product report and display those items in on their individual websites such as in connection with offering a product to be purchased on their website through ecommerce or other associated presentation. Badges 418 or reports 416 can ben retrieved a web page is selected to be displayed on the vendor website 420 or could have been previously sent. Web cache 414 can contain up to date or current reports 416 or badges 418 based on updated in the underlying system (e.g., that are triggered when data changes).

The badges 418 and/or reports 416 may have been originally stored in the blockchain 402 and sent to vendor website 420 through web server 406. This includes the situation in which the blockchain 202 stores data that represent the content of the badges and/or reports 416 such that the badges 418 and/or reports 416 can be generated in the process following the retrieval from the blockchain 202. Web server 406 and web cache 414 and API server 404 can be configured to update the contents of the web cache server when there is a change in the blockchain and/or another trigger. Rules Engine 422, rules database 428, operation database 424, and blockchain 202 are configured to cooperatively perform the processes and functionality described above and herein. The rules snapshot 430 can refer to the snapshots illustratively described herein (meaning it may not literally be only for “rules”). ETL server 432 is used to collect (from external sources) government/NGO data 434, certification data (from sites 436), and lab/analysis data 438.

As such, embodiments of the present system provide a comprehensive, reliable, repeatable, scalable framework for analyzing, assessing and logging information at a single point in time. It is configured to prevent editing, misrepresenting, or falsification of information.

As should be evident, product information involves a highly dynamic data set and systems, in accordance with the presentation invention, and are configured to digitally capture, assess, stamp and store product information against a highly dynamic data set. The system is configured to possess an immutable copy, a provable copy comparing data against a point-in-time snapshot. This solves product and information provenance against a set of data and creates a storage and retrieval method that is non-corruptible. It prevents editing, misrepresenting, or falsification of information.

The system is configured to allow for multiple inputs from multiple players (e.g., different servers under independent domains) across the entire life-cycle of a product, compares that product against the system's proprietary data and third-party data sources and scores the product accordingly. The system then writes to the existing digital blockchain ledger to create a permanent record of the product data, analysis and score.

The system is configured to have data structures and software that establishes correspondence between information items (e.g., individually) and external data that is used to apply rules to the product information.

The system can be configured to use the blockchain to retrieve a current score and transmit the score and/or graphical representation thereof to a user, such as to display on a product page, so as to provide a current score for that product.

Protocols, algorithms, or functionality described in this application are implemented on computers (e.g., node computers) that are connected by a communications network. The communications network can include the Internet, a cellular network, a telephone network, a computer network, a packet switching network, a wide area network (WAN), a global area network, or other network. Embodiments of the present invention are directed to systems, devices, and methods that perform the protocols and algorithms. Embodiments of the present invention are also related to a non-transient computer-readable medium configured to carry out any one of the methods disclosed herein. The protocols, algorithms, or features can be a set of computer instructions readable by a processor and stored on the non-transient computer-readable medium. Such medium may be permanent or semi-permanent memory such as hard drive, floppy drive, optical disk, flash memory, ROM, EPROM, EEPROM, etc., as would be known to those of ordinary skill in the art. Block or blockchain information may be stored on the non-transient computer-readable medium or the memory. Memory, for example, may be cache memory, semi-permanent memory such as RAM, and/or one or more types of memory used for temporarily storing data.

Processor may include an application specific integrated circuit (ASIC), programmable logic array (PLA), digital signal processor (DSP), field programmable gate array (FPGA), or any other integrated circuit. Processor can also include one or more of any other applicable processors, such as a system-on-a-chip that combines one or more of a CPU, an application processor, and memory, or a reduced instruction set computing (RISC) processor.

It is understood that embodiments of the present invention are computer-implemented systems or processes.

Exemplary systems, devices, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention.

Thus, for example, any sequence(s) and/or temporal order of steps of various processes or methods (or sequence of device connections or operation) that are described herein are illustrative and should not necessarily be interpreted as being restrictive. Accordingly, it should be understood that, although steps of various processes or methods or connections or sequence of operations may be shown and described as being in a sequence or temporal order, they are not necessarily limited to being carried out in any particular sequence or order. Moreover, in some discussions, it would be evident to those of ordinary skill in the art that a subsequent action, process, or feature is in response to an earlier action, process, or feature (even though not explicitly stated).

It is also implicit and understood that the applications or systems illustratively described herein provide computer-implemented functionality that automatically performs a process or process steps unless the description explicitly describes user intervention or manual operation.

It is also implicit and understood that the applications or systems illustratively described herein include a computer that includes non-transitory or non-volatile computer-readable memory that stores computer-readable instructions that when executed by a computer perform processes, steps, or operations that are described herein (implicitly or explicitly).

It should be understood that claims that include fewer limitations, broader claims, such as claims without requiring a certain feature or process step in the appended claim or in the specification, clarifications to the claim elements, different combinations, and alternative implementations based on the specification, or different uses, are also contemplated by the embodiments of the present invention.

It should be understood that combinations of described features or steps are contemplated even if they are not described directly together or not in the same context.

The terms or words that are used herein are directed to those of ordinary skill in the art in this field of technology and the meaning of those terms or words will be understood from terminology used in that field or can be reasonably interpreted based on the plain English meaning of the words in conjunction with knowledge in this field of technology. This includes an understanding of implicit features that, for example, may involve multiple possibilities, but to a person of ordinary skill in the art, a reasonable or primary understanding or meaning is understood.

What is claimed is one or more system, method, or computer readable medium that comprises one or more features (e.g., combination of features) described herein, that can include generic claim elements based on species or embodiments described or understood from the present description.

It should be understood that combinations of described features or steps are contemplated even if they are not described directly together or not in the same context.

Exemplary systems, devices, and methods are described for illustrative purposes. Further, since numerous modifications and changes will readily be apparent to those having ordinary skill in the art, it is not desired to limit the invention to the exact constructions as demonstrated in this disclosure. Accordingly, all suitable modifications and equivalents may be resorted to falling within the scope of the invention. Applications of the technology to other fields are also contemplated.

Although the disclosure herein has been described with reference to particular aspects, it is to be understood that these aspects are merely illustrative of the principles and applications of the present disclosure. It is therefore to be understood that numerous modifications may be made to the illustrative aspects and that other arrangements may be devised without departing from the spirit and scope of the present disclosure as defined by the appended claims. Therefore, embodiments of the present disclosure have not been described for limiting purposes.

What is claimed is:

1. A computer implemented method for using blockchain for intelligent classification for product sustainability pedigree identification and estimation by a processor, comprising:
receiving input data from a manufacturer of a product that specify details of a product pedigree related to sustainability;
store external data from third party data sources that specify reference, threshold, or warning information that is associated with individual information items in the input data;
implement a rules engine that contains a collective set of rules that are executed to generate a score representing an accurate estimation of a sustainability of the product based on the received input data,
apply at least a portion of the input data to the rules engine and in response, generate the score for that product;
apply a cryptographic hash function to produces a checksum for each of the input data and generate a global unique identifier for each of the input data;
add each score and each checksum to a blockchain ledger in connection and reuse the checksum and global unique identifier in other blocks when the same data items is used in producing a different score at a different time or a different product; and
generate a graphical representation of score based on retrieving the score from the blockchain and transmit the representation to a user for displaying on the user's website, or printing or placement on physical product, or marketing collateral.

2. The method of claim 1 wherein the method further comprising determining that one of the data inputs has changed in response, triggering, the applying of the data input including the changed data input to the rules engine.

3. The method of claim 1 wherein the method further comprises producing a new score in response to every time a data input or rule changes.

4. The method of claim 1 wherein an application is implemented that is configured to retrieve current and previous scores for a particular product form the blockchain and display a history of scores for the product for browsing by a user.

5. The method of claim 1 wherein implementing in the rules engine a process in which a score is adjusted based on the stored data indicating a lack of alternatives for a data input.

6. The method of claim 1 further comprising adding all data collected as inputs for a particular product on the blockchain.

7. The method of claim 1 wherein the method produces scores in multiple categories and produces a cumulative score by combining the category scores.

8. The method of claim 1 wherein the method immediately updates and records a new score and all of the involved data on the blockchain when a data or rule is changed.

9. The method of claim 1 wherein the method as part of the executing a rules engine uses alternative data information that is used to provide recommendations that would improve the score.
